(19) United States
(12) Patent Application Publication
(10) Pub. No.: US 2017/0307089 A1
(43) Pub. Date: Oct. 26, 2017

(54) Changeover Valve

(71) Applicant: Webasto SE, Stockdorf (DE)

(72) Inventors: Mattias Ahnsjoe, Stockdorf (DE); Jean-Etienne Pousse, Stockdorf (DE)

(21) Appl. No.: 15/520,609

(22) PCT Filed: Sep. 3, 2015
(86) PCT No.: PCT/EP2015/070132

§ 371 Date: Apr. 20, 2017

(30) Foreign Application Priority Data
Oct. 22, 2014 (DE) 10 2014 015 628.1

(51) Int. Cl. F16K 11/056; F16K 27/02

(52) U.S. Cl. CPC F16K 11/056; F16K 27/0245; F16K 27/0263

(57) ABSTRACT

The invention relates to a changeover valve comprising a spherical valve body, which lies against a first valve seat in a first position and lies against a second valve seat in a second position, wherein an opening is provided in a region between the first valve seat and the second valve seat, which opening is adjoined by a further line, which ends at an outlet connection of the changeover valve, wherein the valve body has a diameter d_{Kugel}, and wherein at most a circle having a diameter d_{einschreib} can be inscribed in a projected area defined by an orthogonal projection of the opening onto a selected projection plane, wherein d_{einschreib}<d_{Kugel}, and wherein the projected area is noncircular when the diameter d_{einschreib} of the inscribed circle reaches a maximum in dependence on the selected projection plane.

### CROSS-REFERENCE TO RELATED APPLICATIONS

This application represents the national stage entry of PCT International Application No. PCT/EP2015/070132 filed on Sep. 3, 2015 and claims priority to German Patent Application No. 10 2014 015 628.1 filed on Oct. 22, 2014. The contents of these applications are hereby incorporated by reference as if set forth in their entirety herein.

The invention relates to a changeover valve.

Various embodiments of changeover valves are further described.

An object of the present invention is to provide a changeover valve which with small external dimensions already has a low pressure loss.

There is described a changeover valve having a first input connection and a second input connection which are connected to each other by means of a tubular line inside a housing of the changeover valve, wherein there is arranged in the line a first valve seat which is associated with the first input connection, wherein there is arranged in the line a second valve seat which is associated with the second input connection, wherein there is arranged between the first valve seat and the second valve seat a valve body which can be moved in the line so that the valve body in a first position closes the line at the first valve seat and in a second position closes the line at the second valve seat, wherein in a wall of the line in a region between the first valve seat and the second valve seat there is provided an opening which is adjoined by an additional line which terminates at an output connection of the changeover valve, wherein the valve body is spherical with a diameter d_{Kugel}, and wherein, in a projected face which is defined by means of an orthogonal projection of the opening onto a selected projection plane, at a maximum a circle having a diameter d_{einschreib} can be inscribed, wherein d_{einschreib}<d_{Kugel}, and wherein the projected face is non-round when the diameter d_{einschreib} of the circle which can be inscribed is at a maximum in accordance with the selected projection plane. The tubular line may, for example, be a simple pipe. The tubular line may provide a fluid-directing connection between the first input connection and the second input connection. In the changeover valve described, this connection is generally, that is to say, at least in the two defined switching positions of the changeover valve, interrupted by the valve body. The cross section of the pipe may be circular. The association of the first valve seat with the first input connection may, for example, be understood to mean that the first valve seat is arranged in spatial proximity to the first input connection. The closure of the first valve seat may be able to be identified with the closure of the first input connection. In the same manner, the association of the second valve seat with the second input connection may, for example, be understood to mean that the second valve seat is arranged in spatial proximity to the second input connection. The closure of the second valve seat may be able to be identified with the closure of the second input connection. In the line, the valve body may be able to be moved back and forth between the first valve seat on the first input connection and the second valve seat on the second input connection. The closure of the first valve seat by the valve member may correspond to a first defined switching position of the changeover valve. The closure of the second valve seat by the valve body may correspond to a second defined switching position of the changeover valve. The wall of the tubular line may be a wall of the pipe, wherein the wall of the pipe at the same time forms the outer sheath of the housing. The opening in the region between the first valve seat and the second valve seat which is adjoined by the additional line may, for example, be produced by means of a hole or in another manner so as to perforate the wall of the tubular line. For example, with a circular hole through the wall of a circular pipe, the opening in the curved surface of the wall of the circular pipes forms an ellipse. The changeover valve may, as a result of the specific shape of the opening with respect to the output connection, enable a parallel operation which is linked with very low pressure losses. During the parallel operation, both input connections may be connected with identical or at least approximately identical input pressures to the output connection and also supply them. The valve body during the parallel operation may be located in an undefined intermediate state between the first valve seat and the second valve seat. In this intermediate state, the valve body may not completely cover the opening, wherein as a result of the described specific shape of the opening even a particularly low pressure loss within the changeover valve can be achieved.

With the orthogonal projection, the projection of a point onto the selected projection plane is carried out in such a manner that the connection line between the point and the image thereof forms a right angle with the projection plane. The image then has from all points in the projection plane the shortest spacing from the point. The orthogonal projection of the spherical valve body is regardless of the selected projection plane always a circle with the diameter d_{Kugel} of the valve body. There is selected as the projection plane the plane in which the projection of the opening, that is to say, the projected face, has its maximum surface content. The diameter of the maximum circle which can be inscribed is then also at a maximum. This is, for example, the plane whose surface normal is orientated axially parallel with the additional line when the additional line branches perpendicularly from the tubular line. The projection plane can then be at least roughly determined by the additional line, in particular the orientation of the additional line at the intersection of the additional line and the tubular line. If, in the face projected onto this plane, at a maximum a circle having the diameter d_{einschreib} can be inscribed, wherein d_{einschreib} is smaller than the diameter d_{Kugel} of the spherical valve body, the valve body of the changeover valve can be reliably retained within the tubular line between the first valve seat and the second valve seat. If at the same time the projected face is non-round, the opening in the wall of the tubular line is particularly large and nonetheless suitable for retaining the valve body in the tubular line. In this manner, the pressure loss which occurs inside the changeover valve can be counteracted by a large flow cross section in the region of the opening.

At the same time, the outer dimensions of the housing which are limited substantially by the cross section of the line and the additional line in a downward direction are small. The term “round” may be understood to be circular. The term “non-round” may be understood to be “non-circular”. A circle or a circular face may be considered to be the quantity of all the points which have from the center of the circle or the circular face a spacing which is smaller than the radius of the circle or the circular face. The term “circle” may in this instance thus be used in a synonymous manner with the term “circular face”. A face may be understood to be a face which is delimited by an edge. The edge of the face may be understood to be a path/way which extends around the face. The maximum circle which can be inscribed in a face has an edge which is located completely in the face in which it is inscribed. The path which surrounds the face thus surrounds the edge of the inscribed circle completely. The projected face may be coherent or non-coherent. A face may be considered to be non-coherent when it comprises a plurality of part-faces separated from each other. In other words, the edge of the non-coherent face comprises paths which are separated from each other. A circle which can be inscribed in a non-coherent face necessarily has to be surrounded by the edge of the face, wherein a circular face which can be inscribed is identified with a circle which can be inscribed.

Furthermore, there may be provision for the first valve seat and the second valve seat to be arranged in alignment with each other in the line. In this manner, the valve body can be moved particularly easily inside the tubular line back and forth between the first valve seat and the second valve seat so that the resulting changeover valve, at a low pressure difference which exists between the first input connection and the second input connection, can already change between the defined switching states thereof.

There may be provision for the first valve seat and the second valve seat to be arranged apart from each other with a spacing d_{dist} which is greater than double the diameter d_{Kugel} of the valve body. In particular, there may be provision for the spacing d_{dist} to be greater than three times the diameter d_{Kugel} of the valve body. In this manner, the valve body in both defined switching states of the changeover valve may have moved out of the region of the tubular line in which the opening to the other line and the output connection is arranged. The flow cross section between the input connection which is released in each case and the output connection is therefore not limited/influenced by the valve body so that the pressure losses within the changeover valve are small.

There may be provision for the surface content of the projected face to be greater than the surface content of the circular face with the diameter d_{Kugel}. Since the surface content of the projected face is smaller than the surface content of the opening in the curved wall of the line, the flow cross section in the changeover valve is then particularly large and the pressure loss is also particularly small with small dimensions of the housing.

There may also be provision for the projected face to be non-coherent. A face may be considered to be coherent when any two points in the face can be connected to each other on a path which is located completely within the face. Clearly, this may also mean that the projected face comprises a plurality of part-faces which are separated from each other. In this manner, the maximum circle which can be inscribed in the projected face can be reduced without the surface content of the projected face decreasing substantially. A non-coherent projected face may, for example, be produced by the provision of a plurality of mutually separated openings in the wall of the tubular line. It is also possible to have a web which completely bridges the opening and which divides the opening into two part-faces which are separated from each other. The part-faces which are separated from each other may be round per se. However, it is important that the projected face which is formed by the individual part-faces together is non-round.

There may also be provision for the housing which has the line and the additional line to be a T-shaped pipe. There may further be provision for the opening to be able to be resiliently expanded. In this manner, the opening can be temporarily resiliently expanded in order to receive the valve body. The housing may, for example, at least in the region of the opening, be produced from an elastomer material. The production may, for example, be carried out using an (injection) molding operation known per se to the person skilled in the art. The dimensions of the additional line which adjoins the line may be sized in such a manner that the valve body during assembly can be freely moved in the additional line. The valve body may, for example, with application of an assembly force, resiliently deform, in particular resiliently expand, the opening. In this manner, the valve body may be introduced into the region between the first valve seat and the second valve seat. As a result of the resilient deformation of the opening, the sphere which can be inscribed in the projected face can be increased for the duration of the resilient deformation. The assembly force which is required for the resilient deformation of the opening may be sized in such a manner that forces which occur during the operation of the changeover valve and which move the valve body between the first valve seat and the second valve seat are not sufficient to expand the opening. This can be achieved by selecting an elastomer material with suitable resilience/strength.

In particular, there may be provision for the housing to be resiliently bendable, and for the diameter d_{einschreib} of the maximum circle which can be inscribed in the projected face to become greater than the diameter d_{Kugel} of the valve body during the bending of the housing. As a result of the bending of the housing, the tubular line which is arranged in the housing can be directly bent as a whole so that the shape of the opening which is arranged in the pipe wall also changes. In this manner, the diameter of the sphere which can be inscribed in the projected face can also be increased for the duration of the resilient deformation of the housing so that the valve body can be introduced in a simple manner through the opening into the line between the first valve seat and the second valve seat. The resilience/strength of the housing may in this instance be selected in such a manner that the housing during the operation of the changeover valve is not bent by the forces which occur.

The expansion of the opening by means of an assembly force acting on the valve body and the bending of the housing can cooperate during the assembly of the changeover valve.

There may also be provision for there to be provided webs which at least partially bridge the opening. As a result of the provision of webs which at least partially bridge the opening, the diameter of the maximum circle which can be inscribed in the projected face can be reduced. The webs may, for example, be supplied/mounted via the additional line and be secured to the wall of the line, in particular in the region of the opening. For example, the webs may be mountable using resilient clamps on undercuts in the region of the opening, wherein the opening without assembled webs may be sufficiently large to position the valve body through the additional line in the line. The webs may prevent the valve body from being “introduced” into the opening in order to counteract a blockage or a closure of the opening during parallel operation.

The invention will now be explained by way of example with reference to the appended drawings and with reference to preferred embodiments. In the drawings:

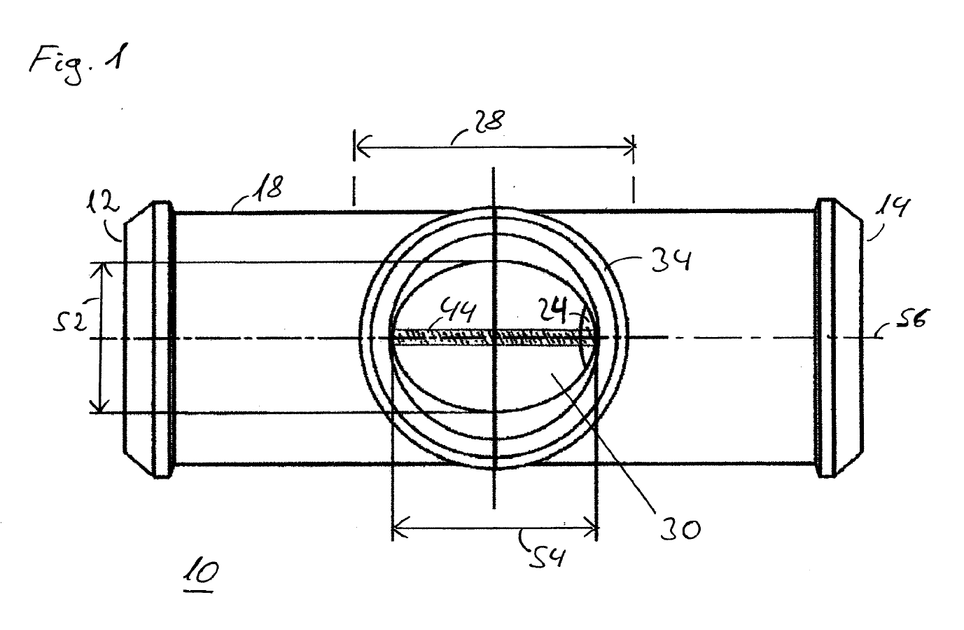

FIG. 1 is a plan view of a changeover valve;

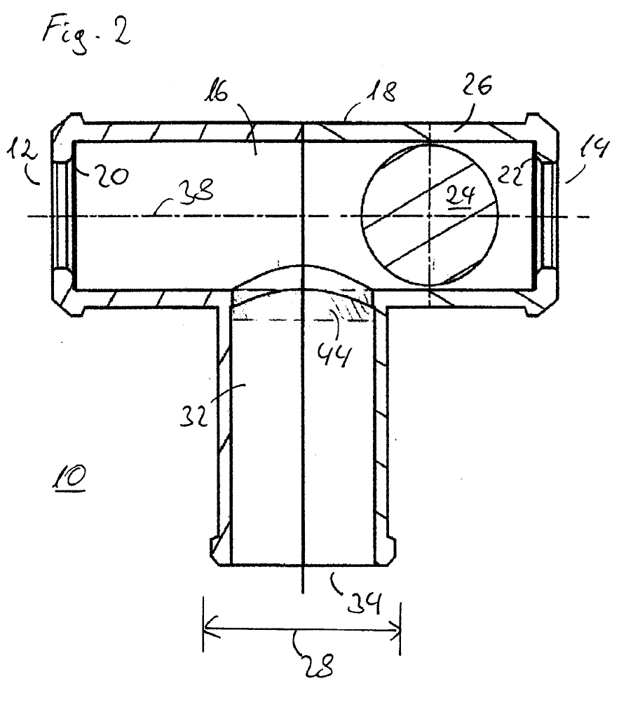

FIG. 2 is a lateral sectioned view of a changeover valve;

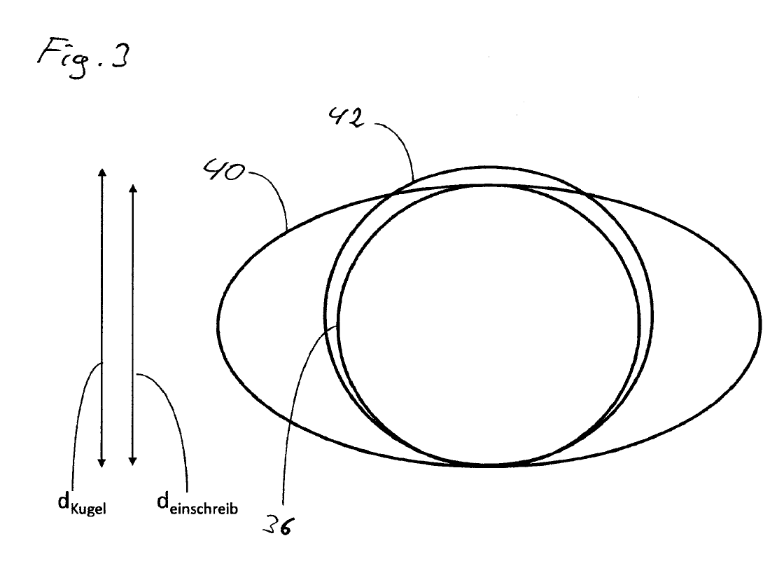

FIG. 3 shows a projected face with an inscribed circle and a projection of the valve body;

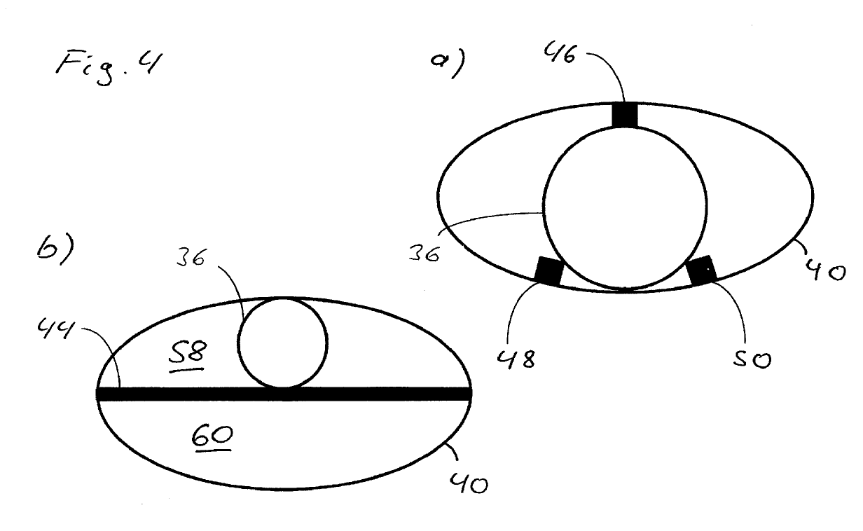

FIG. 4a shows an additional projected face with an inscribed circle;

FIG. 4b shows an additional projected face with an inscribed circle;

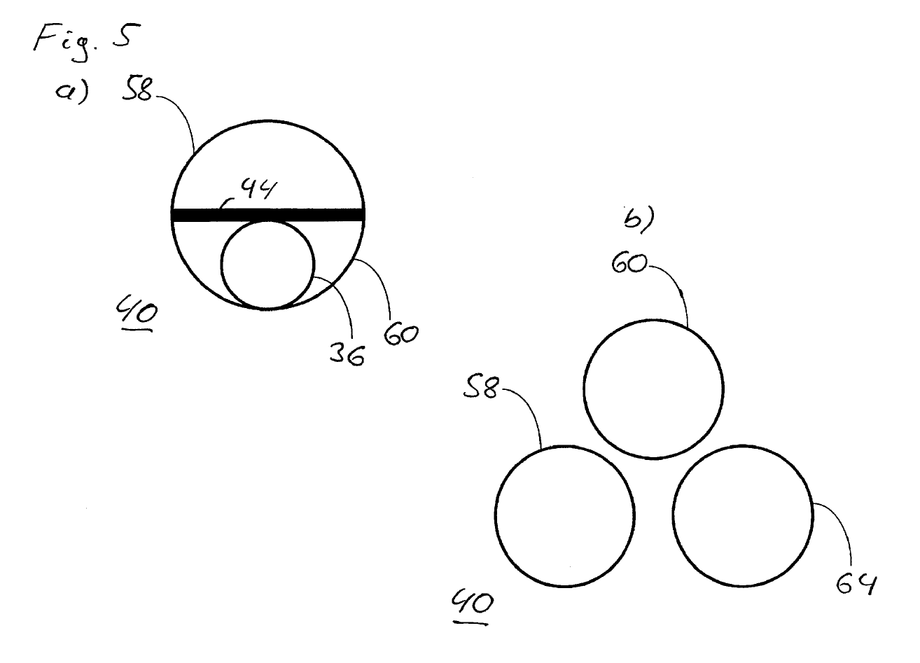

FIG. 5a shows an additional projected face with an inscribed circle;

FIG. 5b shows an additional projected face;

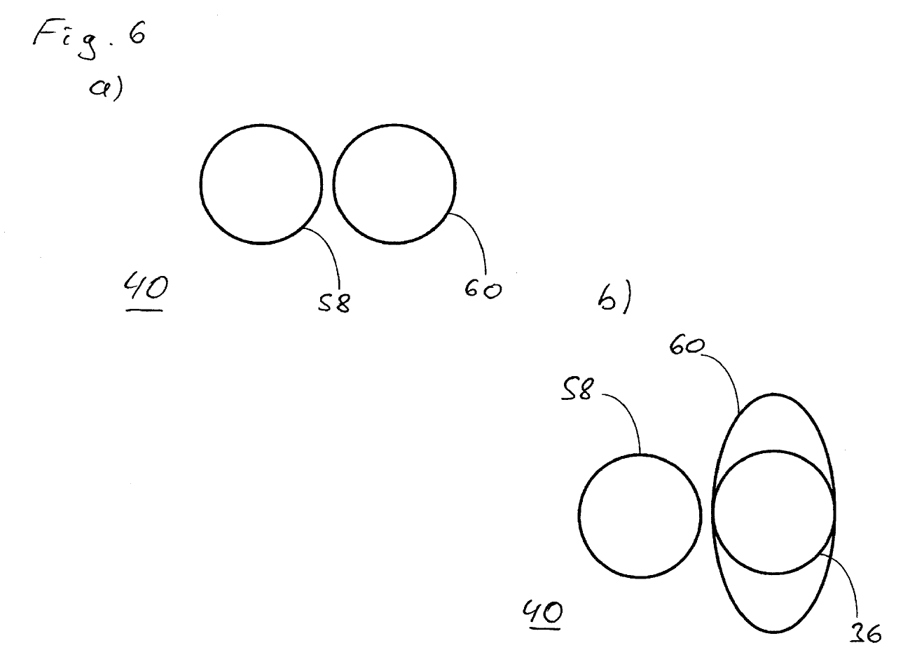

FIG. 6a shows an additional projected face;

FIG. 6b shows an additional projected face with an inscribed circle; and

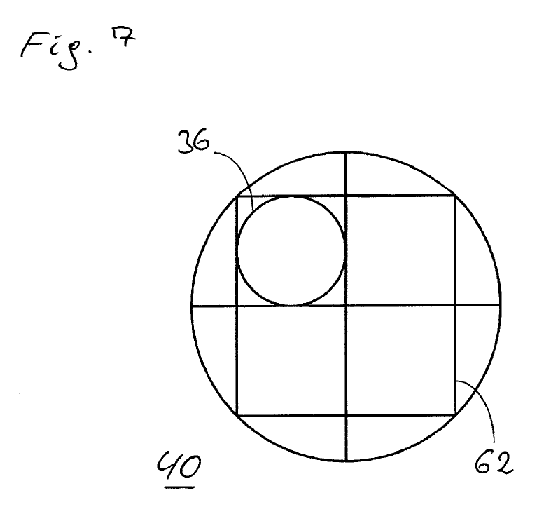

FIG. 7 shows an additional projected face with an inscribed circle.

In the following description of the drawings, the same reference numerals refer to components which are the same or similar.

FIG. 1 is a plan view of a changeover valve 10. It is possible to see in particular a first input connection 12 and a second input connection 14 which are arranged at different ends of a housing 18. The housing 18 has a region 28 which is located between the first input connection 12 and the second input connection 14. An opening 30 is arranged in the region 28. In the region 30 it is possible to see a web 44 which completely bridges the opening 30. The web 44 divides the opening into two part-faces which are separated from each other. Furthermore, a valve body 24 can be partially seen through the opening 30. The web 44 may be mountable after the assembly of the valve body 24 through the opening 30 in order to reduce the opening 30. The valve body 24 is movably arranged inside the housing 18 which will be described in greater detail below in connection with FIG. 2.

The opening 30 has in the plan view illustrated in FIG. 1 the form of an ellipse with a first ellipse diameter d_{A} 52 and a second ellipse diameter d_{B} 54, wherein the ellipse formed by the opening 30 is divided by the web 44 into two halves of equal size. The opening 30 which can be seen in FIG. 1 is accordingly non-coherent since the two halves of the ellipse are separated from each other by the web 44. The plan view selected in FIG. 1 may be considered to be an orthogonal projection, or orthogonal projection. The projection plane is located in this instance in the plane of the page. The opening 30 which can be seen in FIG. 1 can accordingly be identified with the face of the opening 30 projected in the plane of the page. The illustration selected in FIG. 1 shows an output connection 34 of the changeover valve 10 from “above” so that there can be seen from the output connection 34 only concentric circles which surround the ellipsoid opening 30. Between the output connection 34 which can be identified as concentric circles and the ellipsoid opening 30, it is possible to see lid-like faces which can be associated with the housing 18. If the housing 18 can be resiliently deformed, at least in the region of the opening, these lid-like faces can be temporarily resiliently deformed by means of an assembly force acting on the valve member 24 in order to press the valve body through the opening 30. If the housing 18 is on the whole bendable, it is also or additionally possible to resiliently bend the line for assembly of the valve body in order to temporarily increase the opening. The housing 18 may to this end be produced at least partially from an elastomer material with suitable resilience/strength. Depending on how the dimensions of the valve body 24 are in relation to the opening 30, the web can optionally be omitted. The web 44 may comprise a guide for the valve body 24 in order to facilitate a movement of the valve body 24 in the housing 18. In FIG. 1, it is further possible to see a plane of section 56 in the form of a line. The plane of section is thus perpendicular to the plane of the page.

FIG. 2 is a lateral sectioned view of a changeover valve. FIG. 2 shows in particular a lateral sectioned view in the plane of section 56. Inside the housing 18 of the changeover valve 10, the valve body 24 is arranged in a tubular line 16. The cross section of the tubular line 16 may in particular be circular. The valve body 24 is movably arranged between a first valve seat 20 and a second valve seat 22. The first valve seat 20 is associated with the first input connection 12. The second valve seat 22 is associated with the second input connection 14. The association may in particular require spatial proximity. The changeover valve 10 further comprises the output connection 34 which branches via an additional line 32 from the line in the region 28. At the transition between the additional line 32 and the line 16, the optional web 44 which completely bridges the opening 30 is arranged. The changeover valve 10 illustrated in FIG. 2 has two defined switching positions. In the first switching position of the changeover valve 10, the valve body 24 is in abutment with the first valve seat so that the second input connection 14 is connected in a fluid-directing manner to the output connection 34 and the first input connection 12 is sealed with respect to the second input connection 14 and the output connection 34. The second defined switching state of the changeover valve 10 is characterized by the abutment of the valve body 24 against the second valve seat 22 so that the first input connection 12 is connected in a fluid-directing manner to the output connection 34 and the second input connection 14 is sealed with respect to the first input connection 12 and the output connection 34. The valve body 24 may in particular be spherical with a diameter d_{Kugel}. The diameter d_{Kugel} of the valve body 24 may be slightly smaller than the diameter of the line 16 in order to ensure easy movability of the valve body 24 between the first valve seat 20 and the second valve seat 22. Depending on the preferred assembly direction of the changeover valve 10, there may be provided on the inner side of the line for the valve body 24 guides which are not illustrated and which enable, for example, a low-friction rolling of the valve body 24 between the first valve seat 20 and the second valve seat 22 during the transition between the first defined switching position of the changeover valve 10 and the second defined switching position of the changeover valve 10. There may be provision for the web 44 to be a component of a corresponding guide. The spacing between the first valve seat 20 and the second valve seat 22 may in particular be at least twice as large as the diameter of the valve body 24 in order in both defined switching positions of the changeover valve 10 to prevent a partial coverage of the opening region of the additional line 32, that is to say, the opening 30, by the valve body 24. A projection plane 38 which maximizes the circle which can be inscribed in the projected face in the embodiment of FIGS. 1 and 2 is perpendicular to the plane of the page of FIG. 2 and parallel with the plane of the page of FIG. 1.

FIG. 3 shows a projected face with an inscribed circle and a projection of the valve body. A projected face 40 which is illustrated in FIG. 3 may, for example, be in the form of an ellipse. An inscribed circle 36 having the diameter d_{einschreib} can be inscribed in the projected face 40. The inscribed circle 36 which is illustrated in FIG. 3 has the maximum diameter d_{einschreib}. A circular face 42 which is illustrated for comparison and which has the diameter d_{Kugel} which corresponds to the orthogonal projection of the valve body 24 shows that the inscribed circle 36 has a smaller diameter than the circular face 42. This ultimately means that the valve body 24 does not fit through the opening 30 since the orthogonal projection of the valve body 24 cannot be arranged within the projected face 40. It is possible to select as a projection plane 38, onto which the opening 30 is projected orthogonally in order to produce the projected face 40, for example, in the embodiment illustrated in FIGS. 1 and 2 the plane of the page of FIG. 1 in order to maximize the surface content of the projected face 40 and the diameter of the circle 36 which can be inscribed.

FIGS. 4a, 4b, 5a, 5b, 6a, 6b and 7 show additional projected faces with or without resulting inscribed circles of a maximum diameter. FIG. 4a shows a projected face 40, wherein webs 46, 48 and 50 protrude from the lateral edge of the projected face 40 partially into the projected face 40 and in this manner reduce the diameter of the maximum circle 36 which can be inscribed. The webs 46, 48 and 50 may, for example, in the form of studs from the edge of the opening 30, that is to say, starting from the wall 26 of the line 16, at least partially bridge the opening 30. The arrangement of the webs 46, 48, 50 may, for example, be carried out in a uniform manner around the edge of the opening 30. The webs 46, 48, 50 may, for example, be assembled after the valve body 24 has been positioned in the line 16, wherein only by assembling the webs 46, 48, 50 does the diameter of the circle 36 which can be inscribed become smaller than the diameter of the valve body 24.

FIG. 4b shows another projected face with the web 44 which completely bridges the projected face 40 and the resulting circle 36 which can be inscribed, as optionally provided in the embodiment according to FIGS. 1 and 2. The web 44 divides the projected face 40 into a first part-face 58 and a second part-face 60 which are separated from each other by means of the web 44. The resulting maximum circle 36 which can be inscribed is accordingly arranged completely in one of the two part-faces 58, 60, in this instance, by way of example, in the first part-face 58. The projected face is non-coherent since it comprises two part-faces which are separated by the web 44. The edge which delimits the projected face 40 comprises in the present example paths/edges/ways which are separated from each other and which are enclosed and which extend round the respective part-faces 58, 60. For the sake of completeness, it should be mentioned at this point that a circle with an identical diameter can be inscribed in the second part-face 60 since the first part-face 58 and the second part-face 60 have a particular similarity, the same surface content with the same shape.

FIG. 5a shows a projected face 40 which is similar to FIG. 4b. In a similar manner to FIG. 4b, in the projected face which is illustrated in FIG. 5a a web 44 which divides the projected face 40 is also provided. The first part-face 58 which is formed and the second part-face 60 which is formed together form a face which is similar to a circle, wherein the portion of the circle covered by the web 44 is missing so that the projected face 40 does not represent a complete circular face. The projected face 40 illustrated in FIG. 5a may also therefore be considered to be non-round.

FIG. 5b shows another projected face 40 which can be considered to be non-round. The projected face 40 which is illustrated in FIG. 5b comprises a first part-face 58, a second part-face 60 and a third part-face 64. Each of the part-faces 58, 60, 64 is circular per se. However, the projected face 40 formed by the part-faces 58, 60, 64 may be considered to be non-round. The resulting maximum circle which can be inscribed in this instance has in this example a diameter which corresponds to the maximum diameter of the part-faces 58, 60, 64 which together form the projected face 40.

FIG. 6a shows in a similar manner to FIG. 5b a projected face 40 which comprises circular part-faces 58, 60. However, the projected face formed is not intended to be considered to be round. With a changeover valve which comprises such a projected face 40, it is possible for the valve body with the same input pressures at the two input connections to come to a stop between the two openings in the wall which lead to the output connection. A parallel operation of the changeover valve with particularly low pressure loss is therefore possible, wherein both input connections are connected together with the output connection. For the sake of completeness, it should be mentioned that a corresponding positioning of the valve body for a parallel operation with low pressure loss is also possible with other projected faces 40.

FIG. 6b shows another example of a non-coherent projected face 40. The projected face 40 comprises a circular first part-face 58 and a non-round second part-face 60 which is elliptical. In the example illustrated in FIG. 6b, the maximum circle 36 which can be inscribed is drawn in the second part-face 60. As a result of the dimensions selected, however, the maximum circle 36 which can be inscribed corresponds to the first part-face 58 and could alternatively also be drawn at that location.

FIG. 7 shows another projected face 40. The projected face 40 is divided by means of a web structure 62 into a large number of part-faces which are not shown individually. The web structure 62 is in the example illustrated in FIG. 7 a grid structure. The resulting maximum circle 36 which can be inscribed is drawn in one of the part-faces delimited by the web structure 62.

The features of the invention which are disclosed in the above description, in the drawings and in the claims may be significant for the implementation of the invention both individually and in any combination.

### LIST OF REFERENCE NUMERALS

10 Changeover valve
12 First input connection
14 Second input connection
16 Line
18 Housing
20 First valve seat
22 Second valve seat
24 Valve body
26 Wall
28 Region
30 Opening
32 Additional line
34 Output connection
36 Circle which can be inscribed
38 Projection plane
40 Projected face
42 Circular face
44 Web
46 Web
48 Web
50 Web
52 First ellipse diameter d_{A}
54 Second ellipse diameter d_{B}
56 Plane of section
58 First part-face
60 Second part-face
62 Web structure
64 Third part-face

1. A changeover valve having a first input connection and a second input connection which are connected to each other by means of a tubular line inside a housing of the changeover valve,
wherein there is arranged in the line a first valve seat which is associated with the first input connection,
wherein there is arranged in the line a second valve seat which is associated with the second input connection,
wherein there is arranged between the first valve seat and the second valve seat a valve body which can be moved in the line so that the valve body in a first position closes the line at the first valve seat and in a second position closes the line at the second valve seat,
wherein in a wall of the line in a region between the first valve seat and the second valve seat there is provided an opening which is adjoined by an additional line which terminates at an output connection of the changeover valve,
wherein the valve body is spherical with a diameter d_{Kugel}, and
wherein, in a projected face which is defined by means of an orthogonal projection of the opening onto a selected projection plane, at a maximum a circle having a diameter d_{einschreib} can be inscribed, wherein d_{einschreib}<d_{Kugel}, and
wherein the projected face is non-round when the diameter d_{einschreib} of the circle which can be inscribed is at a maximum in accordance with the selected projection plane.

2. The changeover valve as claimed in claim 1, wherein the first valve seat and the second valve seat are arranged in alignment with each other in the line.

3. The changeover valve as claimed in claim 1, wherein the first valve seat and the second valve seat are arranged apart from each other with a spacing d_{dist} which is greater than double the diameter d_{Kugel} of the valve body.

4. The changeover valve as claimed in claim 3, wherein the spacing d_{dist} is greater than three times the diameter d_{Kugel} of the valve body.

5. The changeover valve as claimed in claim 1, wherein the surface content of the projected face is greater than the surface content of the circular face with the diameter d_{Kugel}.

6. The changeover valve as claimed in claim 1, wherein the projected face is non-coherent.

7. The changeover valve as claimed in claim 1, wherein the housing which has the line and the additional line is a T-shaped pipe and wherein the opening is resiliently expandable.

8. The changeover valve as claimed in claim 7, wherein the housing is resiliently bendable, and wherein the diameter d_{einschreib} of the maximum circle which can be inscribed in the projected face becomes greater than the diameter d_{Kugel} of the valve body during the bending of the housing.

9. The changeover valve as claimed in claim 1, wherein there are provided a plurality of webs which at least partially bridge the opening.

10. The changeover valve as claimed in claim 2, wherein the first valve seat and the second valve seat-are arranged apart from each other with a spacing d_{dist} which is greater than double the diameter d_{Kugel} of the valve body.

11. The changeover valve as claimed in claim 2, wherein the surface content of the projected face is greater than the surface content of the circular face with the diameter d_{Kugel}.

12. The changeover valve as claimed in claim 2, wherein the projected face is non-coherent.

13. The changeover valve as claimed in claim 2, wherein the housing which has the line and the additional line is a T-shaped pipe and wherein the opening is resiliently expandable.

14. The changeover valve as claimed in claim 2, wherein there are provided a plurality of webs which at least partially bridge the opening.

15. The changeover valve as claimed in claim 3, wherein the surface content of the projected face is greater than the surface content of the circular face with the diameter d_{Kugel}.

16. The changeover valve as claimed in claim 3, wherein the projected face is non-coherent.

17. The changeover valve as claimed in claim 3, wherein the housing which has the line and the additional line is a T-shaped pipe and wherein the opening is resiliently expandable.

18. The changeover valve as claimed in claim 3, wherein there are provided a plurality of webs which at least partially bridge the opening.

19. The changeover valve as claimed in claim 4, wherein the surface content of the projected face is greater than the surface content of the circular face with the diameter d_{Kugel}.

20. The changeover valve as claimed in claim 4, wherein the projected face is non-coherent.
